(19) United States
(12) Patent Application Publication
(10) Pub. No.: US 2010/0202168 A1
(43) Pub. Date: Aug. 12, 2010

(54) Power supply circuit

(75) Inventor: Mitsuru Kanno, Tokyo (JP)

Correspondence Address: JORDAN AND HAMBURG LLP, 122 EAST 42ND STREET, SUITE 4000, NEW YORK, NY, 10168, US

(73) Assignee: YUTAKA ELECTRIC MFG. CO., LTD., Tokyo (JP)

(21) Appl. No.: 12/584,658

(22) Filed: Sep. 10, 2009

(30) Foreign Application Priority Data
Oct. 21, 2008 (JP) 2008-270755

(51) Int. Cl. H02M 5/45

(52) U.S. Cl. 363/37

(57) ABSTRACT

The present invention provides a power supply circuit without current transformers. A voltage increasing chopping is is applied to an alternating current input between a common line and another input terminal under control of a control circuit and a voltage increasing chopper circuit and filter, to obtain voltage-increased direct-current voltage at the positive and negative charge sides relative the common line, and to improve the power factor, the stabilized direct-current voltage is converted to alternating current voltage by a subsequent half bridge type DC-AC inverter. High-Frequency components are are removed by an output filter comprising a reactor and condenser. An input current detecting resistance is placed in the common line and an output current detecting resistance is placed at the output filter produce input and output current information for the control circuit.

### BACKGROUND

This invention relates to a power supply circuit. More specifically, this invention relates to alternating-current stabilization with power factor improvement and an uninterruptible power supply circuit.

Conventionally, as stabilized power supply circuits of power-factor improvement type that respective either sides of the alternating current input wire and output wire are connected as a common wire, various circuits have been proposed. For example, the applicant for this patent has already proposed a power supply circuit shown in FIG. 5 in the patent literature 1.

The power supply circuit shown in FIG. 5 was proposed to resolve a problem that prior power supply circuits consumed electricity uselessly. The object of the proposed circuit was to provide a compact power supply circuit with limited number of parts and a high efficiency of decreased electricity consumption. According to the power supply circuit shown in FIG. 5, in a voltage-rising chopper and filter for power factor improvement 32, because switching elements 23 and 24 are connected in an inverse direction each other and in series between the output side of a reactor 11 and a common line 16, the rectifier circuit which was necessary in the prior art could be omitted and consequently, the compact circuit could be realized due to reduced number of parts. Also, reduced number of rectifier diodes enabled to reduce the electricity consumed when the switching elements repeat turning ON/OFF.

### [Parent Literature 1]

Publication of unexamined patent application 2006-158100

### SUMMARY OF THE INVENTION

As for the prior power supply circuit shown in FIG. 5, an input voltage detecting circuit 15, a current-transformer 17 as an input-current detecting and insulating means, and the voltage increasing chopper and filter for power factor improvement 32 are connected between alternating-current input terminals 2 and 3. After the voltage increasing chopper circuit and filter for power factor improvement 32, a DC-AC inverter 37, a filter circuit 96, an output voltage detecting circuit 12, and a current-transformer 13 as output current detecting and insulating means are connected in order. Among those, the input-voltage detecting circuit 15, the secondary coil side of the current transformer 17, the output-voltage detecting circuit 12 and the secondary coil side of the current transformer 13 are connected to a control circuit 43 described later.

As such, the power supply circuit shown in FIG. 5 uses the current-transformers 17 and 13 for detecting input and output currents. Applying the current transformers enables to detect electric current with insulation and highly enhance noise tolerance.

On the other hand, the current transformer is 30 mm×30 mm in size, needing a large mounting area, which prevents to make compact power-supply circuits as a problem. The current transformer is so expensive that it prevents to reduce the cost of the product.

This invention intends to resolve the above-mentioned problems and the object of this invention is to provide a similarly functional power-supply circuit without the current transformers to realize reducing its mounting area and the cost of the product in an alternating-current stabilized power supply circuit or uninterrupted power supply circuit.

The present invention is a power-supply circuit, wherein respective either terminals (3,9) of alternating input terminals (2,3) and alternating output terminals (8,9) are bound together to make it a common line (16), voltage increasing chopping is conducted to alternating current voltage input between the common line (16) and the other input terminal (2) under control by a control circuit (43) in a voltage increasing chopper circuit and filter for power factor improvement (32) to obtain voltage-risen direct current at the positive and negative charge sides of the common line (16) and improve the power factor, stabilized direct current voltages at the positive and negative charge sides are converted to alternating current voltage by subsequent half-bridge DC-AC inverter (37), and high-frequency components are eliminated through an output filter (96) comprising a subsequent reactor (35) and a condenser (36): and which are characterized by that said voltage increasing chopper circuit and filter for power factor improvement (32) comprises the reactor (11) connected to the other input terminal (2) and two switching elements (23,24) connected in an inverse direction each other and in series, the reactor (11) and switching elements (23,24) are used commonly at both the positive and negative charge sides to the common line (16) to conduct voltage-rising chopping, an input current detecting resistance (4) is placed just before the switching elements (23,24) and on said common line (16) and an output current detecting resistance (5) is placed at the input side of the reactor (35) configuring said output filter (96) or between the reactor (35) and condenser (36) in order to obtain input and output current information necessary for said control circuit (43).

The present invention also provides the power supply circuit described above, wherein the voltage increasing circuit and filter for power factor improvement (32) are used as a filter for power factor improvement with sinusoidal input current similar to input voltage by signals of phase-regulated direct-current output voltage.

The present invention also includes the power supply circuit described above, wherein the control circuit (43) has a function to control a voltage increasing rate at the voltage increasing chopper and filter for power factor improvement (32) by regulating a set level of target voltage after voltage increasing according to the degree of alternating current input voltage.

According to the above description, at the voltage-rising chopper and filter for power factor improvement 32, because the switching elements 23 and 24 are connected between the output side of the reactor 11 and common line 16 in an inverse direction to each other and in series, the rectifier circuit which was necessary in prior circuits could be omitted and consequently, the number of parts was reduced to realize the compact product. Also, the reduced number of rectifier diodes enables to reduce the electricity consumption occurring at repetitive ON/OFF of the transitions switching elements.

In addition, because the input current detecting resistance 4 is placed on the common line 16 and just before the switching elements 23 and 24, and the output current detecting resistance 5 is placed at the input side of the reactor 35 configuring said output filter 96 or between the reactor 35 and condenser 36 in order to obtain input and output current information which are needed for said control circuit 43, the input and output current information can be obtained without the prior current transformers requiring large mounting areas, but with compact resistance elements requiring only smaller mounting areas. Moreover, the alignment of the input and output current detecting resistances (4, 5) in this invention enable to read the current level even in case of earth fault at the output side and thus protect the device appropriately.

According to the description above, the voltage-rising chopper circuit and filter for power factor improvement 32 is used as a filter for power factor improvement in which input current is made like sinusoidal waves similar to input voltage's by signals of phase-regulated direct-current output voltage. Thus, the output with improved power factor can be obtained.

According to the invention described above, the control circuit 43 has a function to regulate the set level of a target voltage after voltage increasing according to the degree of alternating current input voltage and control the voltage increasing rate at the voltage-rising chopper circuit and filter for power factor improvement 32. For example, when the input voltage is low (less than 107V AC), its target voltage after voltage increasing is set at 151V DC, and with the high input voltage (107V AC or higher), its target voltage after voltage increasing is set at 151V DC or higher in parallel to the input voltage. As such, the control circuit 43 controls to maintain the voltage increasing rate at a low level and consequently, realize the higher efficiency.

### BRIEF DESCRIPTION OF THE DRAWINGS

FIG. 1 is a circuit diagram showing the configuration of the power supply circuit of this invention.

FIG. 2 is a circuit diagram showing a different alignment embodiment 1 of the input current detecting resistance (4) and an output current detecting resistance (5).

FIG. 3 is a circuit diagram showing a different alignment embodiment 2 of the input current detecting resistance (4) and output current detecting resistance (5).

FIG. 4 is a circuit diagram showing a different alignment embodiment 3 of the input current detecting resistance (4) and output current detecting resistance (5).

FIG. 5 is a circuit diagram showing a configuration of a power supply circuit using current transformers.

### DETAILED DESCRIPTION

The power supply circuit of this invention is a power-supply circuit, wherein respective either terminals of alternating current input terminals (2,3) and alternating current output terminals (8,9) are bound together to make it a common line (16), voltage increasing chopping is conducted to alternating current voltage input between the common line (16) and the other input terminal (2) under control of a control circuit (43) in a voltage increasing chopper circuit and filter for power factor improvement (32) to obtain voltage-risen direct current at the positive and negative charge sides of the common line (16) and improve the power factor, stabilized direct current voltage at the positive and negative charge sides is converted to alternating current voltage by subsequent half-bridge DC-AC inverter (37), and high-frequency components are eliminated through an output filter (96) comprising a subsequent reactor (35) and a condenser (36): and which is characterized by that said voltage increasing chopper circuit and filter for power factor improvement (32) comprises the reactor (11) connected to the other input terminal (2) and two switching elements (23,24) connected in an inverse direction each other and in series, the reactor (11) and switching elements (23,24) are used commonly at both the positive and negative charge sides to the common line (16) to conduct voltage-rising chopping, an input current detecting resistance (4) is placed just before the switching elements (23,24) and on said common line (16) and an output current detecting resistance (5) is set at the input side of the reactor (35) configuring said output filter (96) or between the reactor (35) and condenser (36) in order to obtain input and output current information necessary for said control circuit (43).

Using drawings, detailed description is presented below.

### EMBODIMENT 1

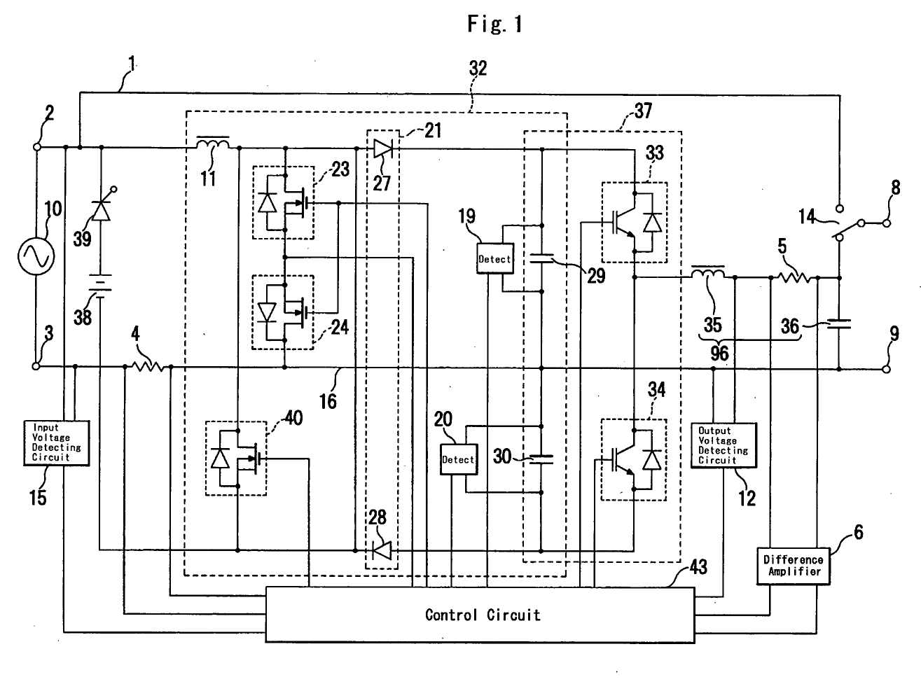

Based on the circuit diagram shown in FIG. 1, the configuration of the power supply circuit of this invention is described. In FIGS. 1, 2 and 3 are alternating current input terminals to connect an alternating current power supply 10. 8 and 9 are alternating current output terminals after stabilization. Among these input and output terminals, the interval between the alternating current input terminal 3 and the alternating current output terminal 9 is connected directly to the common line 16 and the interval between the alternating current input terminal 2 and the alternating current output terminal 9 is connected through the direct line 1 and switching circuit 14. As such, the direct circuit is configured.

The output voltage detecting circuit 15 and the voltage increasing chopper and filter for power factor improvement 32 are connected to the alternating current input terminals 2 and 3. Just after the voltage increasing chopper and filter for power factor improvement 32, the filter circuit 96 follows the DC-AC inverter 37, and includes the reactor 35 and the condenser 36, and the output voltage detecting circuit 12 are connected in order. In the common line 16 and just before the voltage increasing chopper circuit and filter for power factor improvement 32, the input current detecting resistance 4 is placed and the output current detecting resistance 5 is placed between the reactor 35 configuring the output filter 96 and the condenser 36.

Among these, information from the input-voltage detecting circuit 15, input-current detecting resistance 4, output-voltage detecting circuit 12 and output-current detecting resistance are input to the control circuit 43 described later. A difference amplifier 6 is placed on the signal route through which information of the output-current detecting resistance 5 is transmitted to the control circuit 43.

As shown in FIG. 1, said voltage increasing chopper circuit and filter for power factor improvement 32 comprises the reactor 11 connected to the other input terminal 2, the switching elements 23 and 24 comprising MOSFET with flywheel diodes which are connected in an inverse direction each other and in series and placed between the output side of the reactor 11 and the common line 16, the flywheel diode 21 comprising the rectifier diode 27 placed on the positive-charge side which is furcated from the output side of said reactor 11 and the rectifier 28 placed on the negative-charge side which is furcated from the output side of said reactor 11, the condenser 29 placed between said positive-charge line and common line 16, and the condenser 30 placed between said negative-charge line and common line 16. The voltage increasing chopper circuit and filter 32 for power factor improvement comprising these elements is a configuring part used commonly in both positive and negative charge sides to the common line 16 and increases voltages at both positive and negative charge sides. Among these, the gates of the switching elements 23 and 24 are connected to the control circuit 43 described later. The condensers 29 and 30 are connected to the detecting circuit 19 of the positive side and the detecting circuit 20 of the negative side, respectively. The detection results of these detecting circuits 19 and 20 are input to the control circuit 43.

Said DC-AC inverter 37 comprises the switching elements 33 and 34 comprising IGBT, and a half-bridge type comprising the condensers 29 and 30. The condensers 29 and 30 are used commonly with the configuring parts of said voltage increasing chopper circuit and filter for power factor improvement 32. Among these, the gates of the switching elements 33 and 34 are connected to the control circuit 43. The DC-AC inverter 37 converts direct current to alternating current and subsequently, the filter circuit 96 comprising the reactor 35 and condenser 36 compresses high-frequency components of inverted alternating-current voltage to output.

The control circuit 43 detects input voltage and current through the input-voltage detecting circuit 15 and input-current detecting resistance 4 which are connected to the control circuit 43 and based on this, controls the ON/OFF of the switching elements 23 and 24 in said voltage increasing chopper circuit and filter for power fraction improvement 32 to conduct the voltage-increasing action at the positive and negative charge sides. Based on detection results of the detecting circuits 19 and 20 connected to the condensers 29 ad 30, respectively, and output voltage and current detected through the output voltage detecting circuit 12 and output current detecting resistance 5, the control circuit 43 controls the ON/OFF of the switching elements 33 and 34 in said DC-AC inverter 37 and then controls the production of alternating voltage output from the alternating current output terminals 8 and 9.

A battery 38 and reflux-preventive switch element 39 connected in series are placed between the input side of said reactor 11 and the cathode side of the diode 28. This battery 38 is for supplying electricity at the time of electricity failure of commercial power supply. The reflux-preventive switch element 39 is for preventing the battery 38 from discharging electricity when alternating-current input voltage decreases.

Here, 40 is a switch element to act when alternating-current input voltage decreases. When the input decreases and electricity failure is judged, the reflux-preventive switch 39 turns on. Then, the voltage of the battery 38 is added to the switch element 40 to form a chopper circuit at the reactor 11, diodes 27 and 28. Even at electricity failure, voltage-risen voltage is accumulated at the condensers 29 and 30 and the DC-AC inverter 37 converts to alternating current and then outputs it.

Next, based on drawings, actions of above circuits are described. Said voltage increasing chopper circuit and filter for power factor improvement 32 acts commonly at both positive and negative charge sides. There are some differences in acting elements according to positive or negative alternating-current input from the alternating-current power supply 10. However, because it is based on the same principle basically, the positive case of alternating current input is mainly described. In FIG. 1, when the alternating-current power supply 10 is applied between the alternating-current terminals 2 and 3, the input voltage detecting circuit 15 detects input voltage and the detection result is transmitted to the control circuit 43. Then, the control circuit 43 acts to turn on the gates of the switching elements 23 and 24. For opening and closing of the gates, a high frequency of 20 kHz is used. In positive case of alternating-current input, when the switching elements 23 and 24 turn on, a current flows in a loop of the alternating-current power supply 10, reactor 11, switching element 23, switching element 24 and alternating-current power supply 10 to accumulate energy at the reactor 11.

Next, when the switching elements 23 and 24 turn off, the energy accumulated at the reactor 11 is discharged to cause a current-flow in a route of the alternating-current power supply 10, reactor 11, diode 27, condenser 29 and alternating-current power supply 10, and then, voltage-risen voltage is accumulated at the condenser 29. The direct-current voltage accumulated at the condenser 29 is made by pulse-duration modulation by switching action of the switching element 33 of the DC-AC inverter 37, to which the filter circuit 96 compresses high-frequency components. The compressed components are output as alternating-current voltage of the positive side from the alternating current output terminals 8 and 9.

In the positive side case of alternating current input from the alternating current power supply 10, similarly, when the switching elements 23 and 24 turn on, a current flows in a loop of the alternating current power supply 10, switching element 24, switching element 23, reactor 11 and alternating current power supply 10 to accumulate energy at the reactor 11. Then, once the switching elements 23 and 24 turn off, the energy accumulated at the reactor 11 is discharged to cause a current flow in a route of the alternating current power supply 10, condenser 30, diode 28, reactor 11, and alternating current power supply 10 and then an accumulation of voltage-risen voltage at the condenser 30. The direct-current voltage accumulated at the condenser 30 is output as alternating current voltage of the negative side from the alternating output terminals 8 and 9 by switching action of the switch 33 of the DC-AC inverter 37 and compression of high-frequency components through the filter circuit 96.

As such, in the power supply circuit of this invention, because the switching elements with the flywheel diodes 23 and 24 connected in an inverse direction each other and in series are inserted between the alternating current input terminals 2 and 3 and just after the reactor 11, the alternating-current voltage rectifier element becomes unnecessary and current's flowing at the diodes in this invention enables to reduce the unnecessary consumption of electricity.

Specifically, with voltage at the diodes 0.6V, resistance RDS between drain and source at ON time of the switching elements=0.02 W, mean input current=10 A, and switching-on mean duty=0.5, the consumed electricity in prior circuits using diodes as alternating-current voltage rectifier elements is:

(1.2V′10 A′0.5+1.2V′10 A′0.5) '2=24 W

On the other hand, the consumed electricity in this invention is:

(10 A′10 A′0.02 W '0.5+0.6V′10 A′0.5) '2=8 W

Thus, it is clearly found that this invention reduces the consumption by 16 W. Actually, due to effects of other elements, the difference is greater.

In the voltage increasing chopper circuit and filter for power factor improvement 32, input voltage is accumulated at the condensers 29 and 30 and the high efficiency is realized by controlling the voltage-increasing rate at the control circuit 43. In the configuration of this invention, because necessary voltages accumulated at the condensers 29 and 30 in said DC-AC inverter 37 are about output voltage +10V DC, respectively, when 100V AC is necessary as output voltage, 141V DC(100V AC′√2)+10V DC=151 VDC is sufficient. Thus, the target voltage set at 151 VDC enables to output 100V AC as an output voltage. However, although there is no problem with 151V DC of the target voltage when input voltage is low, when input voltage exceeds 107V AC (151V DC/√2) in this setting condition, input voltage becomes higher than voltage after voltage increasing to cause stopping of the switching action of the switching elements 23 and 24 and stopping improving the power factor. To avoid this, usually, the target voltage after voltage increasing is set at higher voltage than the maximum input voltage. However, in this setting, when alternating-current voltage is low, voltage-increasing rate becomes so high that the electricity efficiency decreases, which is a problem.

Thus, in this invention, the control circuit 43 controls the target voltage risen at the said voltage-increasing chopper circuit and filter for power factor improvement 32 according to input voltage detected at the input voltage detecting circuit 15. For example, when the input voltage is low (less than 107V AC), the target voltage risen is set at 151V DC or higher, and when the input voltage is high (107V AC or higher), the target voltage is set at 151V DC or higher in parallel to the input voltage. As such, the voltage increase rate can be kept at a low condition and the high efficiency can be realized.

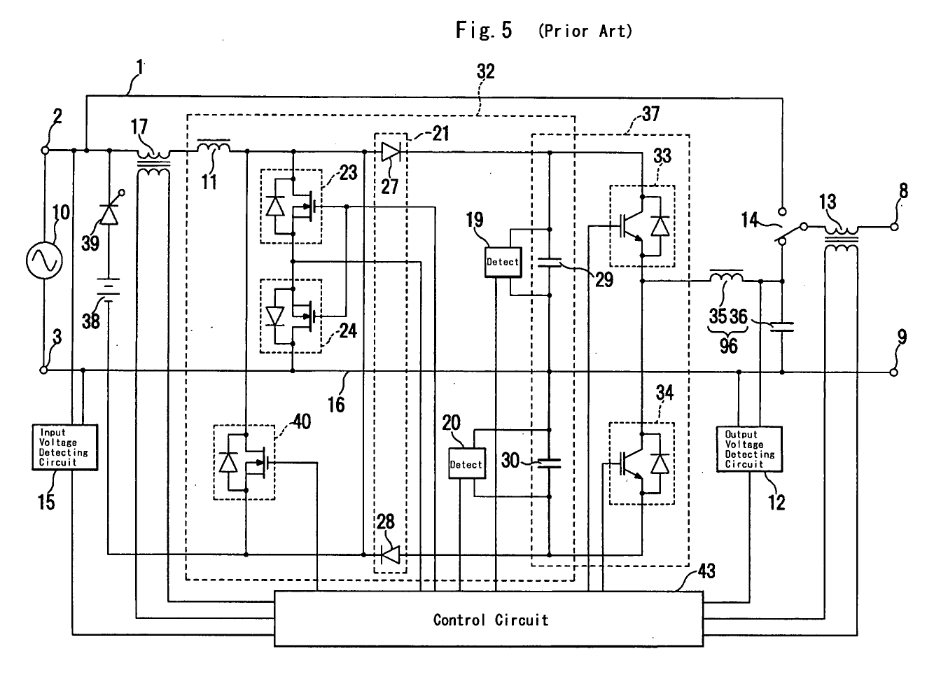

The most notable configuration in this invention is the placement of the input current detecting resistance 4 on the common line 16 just before the voltage-increasing chopper circuit and filter for power fracture improvement 32 in place of the current transformers 17 and 13 used in prior circuits shown in FIG. 5.

To describe the effect of such alignment of the current detecting resistance, other alignment embodiments of the input current detecting resistance 4 and output current detecting resistance 5 are described. In the following alignment embodiments 1-3, all the configurations except for the input and output current detecting resistances 4 and 5 are common.

### [Alignment Embodiment 1]

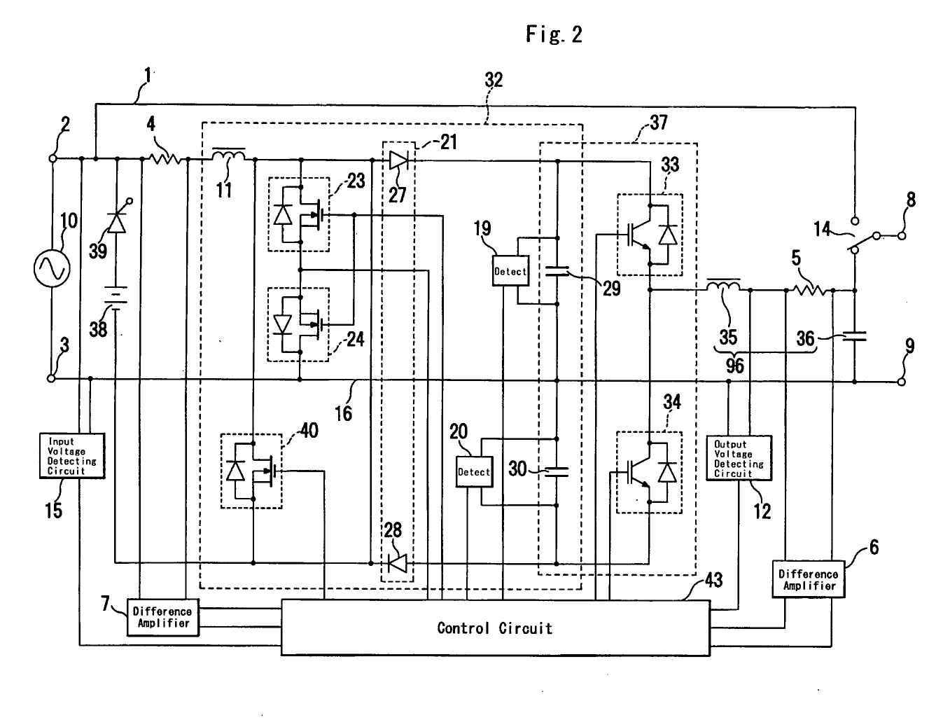

FIG. 2 is alignment embodiment 1 which is different in the input and output current detecting resistances 4 and 5 from this invention's. In this alignment embodiment 1 shown in FIG. 2, the input current detecting resistance 4 is placed at the position where the current transformer 17 was placed previously as shown in FIG. 5, and the output current detecting resistance 5 is placed between the reactor 35 and condenser 36 configuring the output filter 96. In such configuration, to eliminate the adverse effect of noise from the input side and match the control circuit 43 and a ground point, it is necessary to have such a configuration that input and output voltage information is input to the control circuit 43 through respective difference amplifiers 6 and 7.

The alignment embodiment 1 shown in FIG. 2 enables to detect input and output voltage information without the current transformers 17 and 13. However, because two difference amplifiers 6 and 7 are needed to prevent error action due to noise from the input side and match the control circuit 43 and a ground point, the effect from the viewpoint of compact size of actual mounting area is small.

### [Alignment Embodiment 2]

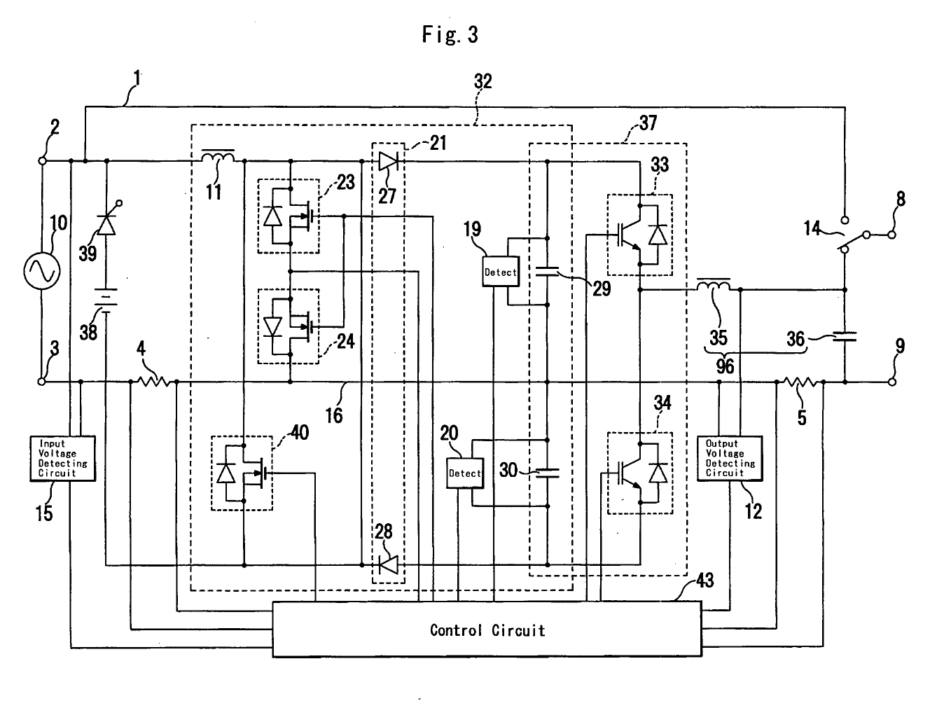

FIG. 3 is alignment embodiment 2 which is different in the input and output current detecting resistances 4 and 5 from this invention's. In this alignment embodiment 2 shown in FIG. 3, the input current detecting resistance 4 and output current detecting resistance 5 are placed on the common line 16. In such alignment, the difference amplifiers 6 and 7 which were needed in alignment embodiment 1 because of the difference in ground point become unnecessary and the effect from the viewpoint of compact size of actual mounting area is very great. The alignment on the common line 16 is advantageous to improve noise-tolerance.

However, in alignment embodiment 2 shown in FIG. 3, although current can be detected by the output current detecting resistance 5 when a short circuit is made between the alternating current output terminals 8 and 9, when the alternating current output terminal 8 is made an earth fault, the current levels cannot be detected for both input and output and the power supply equipment cannot be protected, which is a problem. Thus, products applying alignment embodiment 2 are incomplete as products.

### [Alignment Embodiment 3]

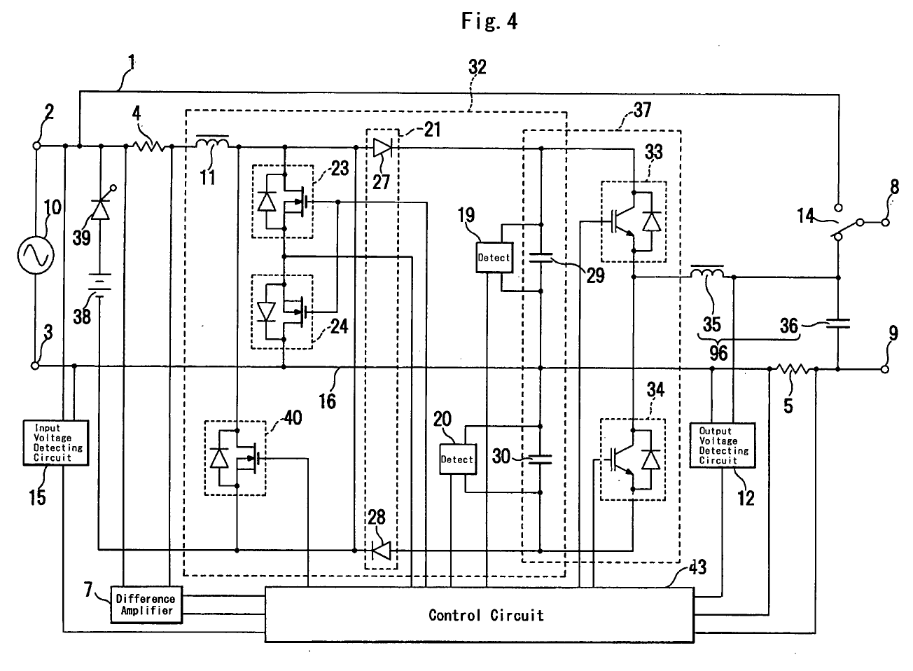

FIG. 4 is alignment embodiment 3 which is different in the input and output current detecting resistances 4 and 5 from this invention's. In alignment embodiment 3 shown in FIG. 4, the input current detecting resistance 4 is placed at the position where the current transformer 17 was placed in FIG. 5 and the output current detecting resistance 5 is placed on the common line 16. In such alignment, the current detection when the alternating current output terminal 8 is made an earth fault, which caused a problem in alignment embodiment 2 can be done at the input current detecting resistance 4. Thus, the problem in alignment embodiment 2 resolves.

However, in alignment embodiment 3 shown in FIG. 4, to detect current in earth fault cases of the alternating current output terminal 8 at the input current detecting resistance 4, separate configurations for peak cut are needed for both the output and input sides and the effect from the viewpoint of compact size of actual mounting area becomes thus small.

[Effects of the Alignment in this Invention]

On the other hand, the alignment of the input current detecting resistance 4 and output current detecting resistance 5 in this invention shown in FIG. 1 enables to detect current by the output current detecting resistance 5 when the alternating current output terminal 8 is made an earth fault. Thus, advantageous points of this invention are that the problems in alignment embodiments 2 and 3 resolve and the actual mounting area is smaller than that of alignment embodiment 1.

As such, the alignment of the input current detecting resistance 4 and the output current detecting resistance 5 in this invention enables to resolve multiple subjects, including current detection in earth fault cases of the alternating current output terminal 8, difference in ground point with the control circuit 43, noise tolerance from the input side, and compact size of actual mounting area of the whole circuit.

In the configuration of this invention shown in FIG. 1, the direct line 1 for direct output of commercial power supply is placed to switch at the switch circuit 14. Although current cannot be detected at switching to the direct line 1 side in alignment embodiment 1, the alignment in this invention enables to detect current by the input current detecting resistance 4 placed on the common line 16, which is advantageous.

In the embodiment shown in FIG. 1, while the output current detecting resistance 5 is placed between the reactor 35 and condenser 36 configuring the output filter 96, the output current detecting resistance 5 can be placed just before the reactor 35, namely between the DC-AC inverter 37 and reactor 35.

On the other hand, if the output current detecting resistance 5 is placed just after the condenser 36 configuring the output filter 96, the current level after smoothing is detected and the response speed to the change in current level thus delays, which prevents appropriate control. Accordingly, it is desirable to detect the current level before smoothing.

In the embodiment 6, although the switching elements 23 and 24 are configured by MOSFETs containing flywheel diodes, this invention is not limited to this. For example, it can be configured by only MOSFETs without flywheel diodes or by elements other than this, including switching elements such as bipolar transistors and IGBTs. In case of a switching element such as bipolar transistor and IGBT, it is desirable to use those containing flywheel diodes. Moreover, the switching elements 33 and 34 are not limited to an IGBT and other switching elements such as a MOSFET are also usable.

1-3. (canceled)

4. A power supply circuit, comprising:
first and second input terminals for accepting an alternating current and voltage input and first and second output terminals for outputting a stabilized alternating voltage and current output;
a common line extending through the power supply and interconnecting said first input terminal to said first output terminal;
a voltage increasing chopper and filter circuit accepting voltage input across said first and second input terminal and converting the alternating current and voltage input to positive and negative DC voltages stabilized and stored relative to said common line, said positive and negative DC voltages being respectively greater in value than positive and negative peaks of the alternating current and voltage relative to said first input terminal;
a half-bridge DC-AC inverter accepting said positive and negative DC voltage and converting said positive and negative DC voltage to an alternating current and voltage output provided at a DC-AC inverter output;
an output filter accepting the alternating current and voltage output from said DC-AC inverter output, said output filter including an output reactor and an output condenser arranged to filter out high frequency components of the alternating current and voltage output and apply said alternating current and voltage output in filtered form to said first and second output terminals with said first output terminal being connected as a common line about which the alternating current and voltage output alternates;
said voltage increasing chopper and filter circuit comprising an input reactor connected to the second input terminal and having a reactor output feeding first and second switching elements disposed between said reactor output and said common line;
said voltage increasing chopper and filter circuit further comprising first and second condensers connected to said first and second switching elements such that said first condenser is charged positive with said positive DC voltage relative to said common line, and said second condenser is charged negative with said negative DC voltage relative to said common line;
an input current detecting resistance in series connection between said first input terminal and said common line so as to be interposed between the first input terminal and the first and second switching elements connected to said common line;
an output current detecting resistance disposed at one of a first position or a second position, wherein at said first position said output current detecting resistance connects said DC-AC inverter output to an input of said output reactor, and at said second position said output current detecting resistance connects an output of said output reactor to said output condenser; and
a controller accepting a first input signal representing an input current in said input current detecting resistance, a second input signal representing an output current in said output current detecting resistance, and said controller being configured and connected to control said first and second switching elements based on said first and second input signals.

5. The power supply circuit according to claim 4, wherein the voltage increasing chopper and filter circuit is controlled by said controller so as to effect power factor improvement converting input current of said alternating current and voltage input to sinusoidal waves similar to input voltage waves of alternating current and voltage input by signals controlling said first and second switching elements so as to produce a phase-regulated direct-current output voltage filter for power factor improvement over the alternating current and voltage input.

6. The power supply circuit according to claim 4, wherein the controller is configured to regulate voltage increase effected by the voltage increasing chopper and filter circuit resulting in the positive and negative DC output voltages based on input voltage levels of the alternating current and voltage input and such that power factor improvement is effected.
